(19) United States
(12) Patent Application Publication
(10) Pub. No.: US 2013/0167148 A1
(43) Pub. Date: Jun. 27, 2013

(54) COMPUTING DEVICE AND VIRTUAL MACHINE OPERATION CONTROL METHOD

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHIU-HUA LU, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/726,252

(22) Filed: Dec. 24, 2012

(30) Foreign Application Priority Data
Dec. 27, 2011 (TW) 100149026

(51) Int. Cl. G06F 9/455; G06F 15/177

(52) U.S. Cl. CPC G06F 9/455; G06F 15/177
USPC 718/1

(57) ABSTRACT

In a virtual machine (VM) operation control method using a computing device, a connection between the computing device and a storage system is established. The computing device receives a user request in relation to a VM. In response to the user request for VM creation or VM update, the computing device downloads a configuration file and a disk image file of the VM from the storage system, and accordingly creates the VM in the computing device. In response to the user request for VM backup, the computing device uploads the configuration file and the disk image file of the VM to the storage system.

### BACKGROUND

1. Technical Field

Embodiments of the present disclosure relate to virtual machine technology, and particularly to a computing device and a virtual machine operation control method.

2. Description of Related Art

A computing device (e.g., a mobile phone or a personal computer) may have one or more virtual machines (VMs) installed for providing multiple services to a user. To ensure data security of the virtual machines, there is a need for a computing device and a virtual machine operation control method.

### BRIEF DESCRIPTION OF THE DRAWINGS

FIG. 1 is one embodiment of a control application of a computing device.

FIG. 2 is a block diagram of one embodiment of function modules of a virtual machine operation control system in FIG. 1.

FIG. 3 is a flowchart of one embodiment of a virtual machine operation control method using the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

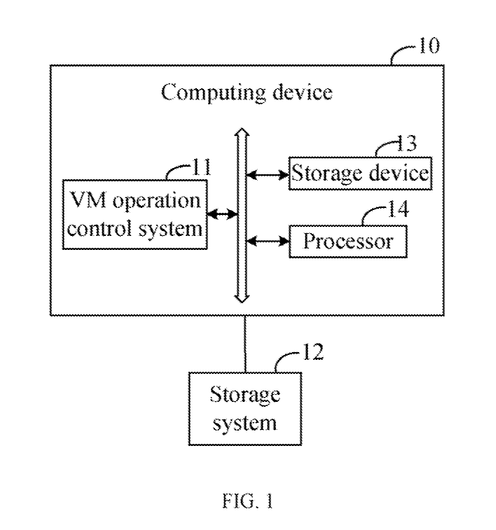

FIG. 1 is one embodiment of a control application of a computing device 10. The computing device 10 includes a virtual machine (VM) operation control system 11. The computing device 10 is connected to a storage system 12 (e.g., a database server). The storage system 12 stores configuration files and disk image files of virtual machines. The virtual machine operation control system 10 performs various virtual machine operations (e.g., virtual machine creation) in response to a user request. The computing device 10 may be a mobile phone, a personal computer, a server, or any other suitable data processing device.

In this embodiment, the computing device 10 further includes a storage device 13 and at least one processor 14. The storage device 13 may be a dedicated memory, such as an EPROM, a hard disk drive (HDD), or a flash memory. In some embodiments, the storage device 13 may be an external storage device, such as an external hard disk, a storage card, or a data storage medium.

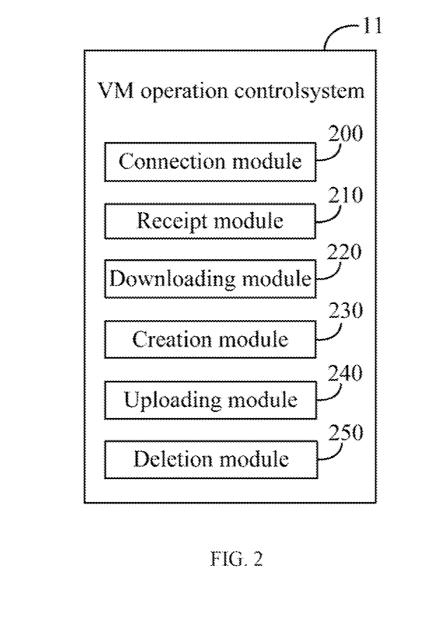

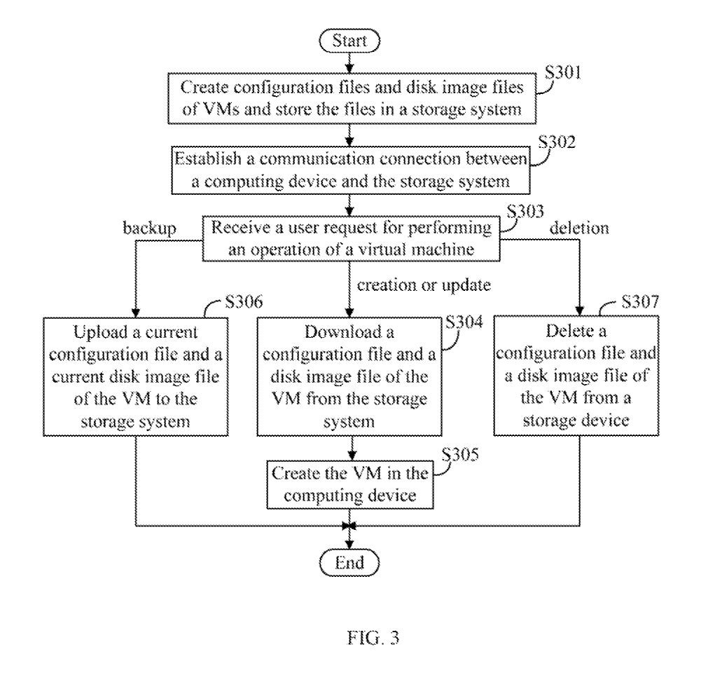

FIG. 2 is a block diagram of one embodiment of function modules of the virtual machine operation control system 11 in FIG. 1. The virtual machine operation control system 11 may include a connection module 200, a receipt module 210, a downloading module 220, a creation module 230, an uploading module 240, and a deletion module 250. The modules 200-250 may comprise computerized code in the form of one or more programs that are stored in the storage device 13. The computerized code includes instructions that are executed by the at least one processor 14, to provide the aforementioned functions of the virtual machine operation control system 11. A description of the functions of the modules 200-250 is given in reference to FIG. 3.

FIG. 3 is a flowchart of one embodiment of a virtual machine operation control method using the computing device 10 of FIG. 1. Depending on the embodiment, additional steps may be added, others removed, and the ordering of the steps may be changed.

In step S301, a plurality of configuration files and disk image files are created and stored in the storage system 12. The configuration files indicate computing resources required by virtual machines. The computing resources may include CPU resource, memory resource, hard disk resource, and network adapter resource. The disk image files indicate various files created and used by each of the virtual machines.

In step S302, the connection module 200 establishes a communication connection between the computing device 10 and the storage system 12. In one embodiment, the computing device 10 is connected to the storage system 12 through a network. The network may be the a public or private network.

In step S303, the receipt module 210 receives a user request for performing an operation of a virtual machine in the computing device 10. The virtual machine operation may be a creation operation, an update operation, a backup operation, or a deletion operation. The receipt module 210 may provide a user interface for the input of the user request.

If the user request is for performing a creation operation or an update operation of a virtual machine, in step S304, the downloading module 220 downloads a configuration file and a disk image file of the virtual machine from the storage system 12. The downloading module 220 further stores the downloaded configuration file and the downloaded disk image file into the storage device 13 of the computing device 10.

In step S305, the creation module 230 creates the virtual machine in the computing device 10 according to the downloaded configuration file and the downloaded disk image file. The creation module 230 may allocate required computing resources (e.g., CPU, memory, hard disk, and network adapter) of the virtual machine according to the downloaded configuration file, and create a virtual disk of the virtual machine according to the downloaded disk image file.

If the user request is for performing a backup operation of a virtual machine, in step S306, the uploading module 240 uploads a configuration file and a disk image file of the virtual machine to the storage system 12. The virtual machine can be restored and reinstated according to the uploaded configuration file and the uploaded disk image file of the virtual machine.

If the user request is for performing a deletion operation of a virtual machine, in step S307, the deletion module 250 deletes the configuration file and the disk image file of the virtual machine from the storage device 13.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A virtual machine operation control method being executed by a processor of a computing device, the method comprising:
establishing a communication connection between the computing device and a storage system connected to the computing device;
receiving a user request for performing a creation operation, an update operation, or a backup operation of a virtual machine in the computing device;
downloading a configuration file and a disk image file of the virtual machine from the storage system in response to the user request for performing the creation operation or the update operation of the virtual machine, and storing the configuration file and the disk image file into a storage device of the computing device;
creating the virtual machine in the computing device according to the configuration file and the disk image file; and
uploading the configuration file and the disk image file of the virtual machine to the storage system in response to the user request for performing the backup operation of the virtual machine.

2. The method of claim 1, wherein the computing device is connected to the storage system through a network.

3. The method of claim 1, further comprising:
receiving a user request for performing a deletion operation of the virtual machine.

4. The method of claim 3, further comprising:
deleting the configuration file and the disk image file of the virtual machine from the storage device in response to the user request for performing the deletion operation of the virtual machine.

5. The method of claim 1, wherein the configuration file of the virtual machine indicates computing resources required by the virtual machine.

6. A computing device, comprising:
a storage device;
at least one processor; and
a virtual machine operation control system comprising one or more programs that are stored in the storage device and executed by the at least one processor, the one or more programs comprising instructions to:
establish a communication connection between the computing device and a storage system connected to the computing device;
receive a user request for performing a creation operation, an update operation, or a backup operation of a virtual machine in the computing device;
download a configuration file and a disk image file of the virtual machine from the storage system in response to the user request for performing the creation operation or the update operation of the virtual machine, and store the configuration file and the disk image file into a storage device of the computing device;
create the virtual machine in the computing device according to the configuration file and the disk image file; and
upload the configuration file and the disk image file of the virtual machine to the storage system in response to the user request for performing the backup operation of the virtual machine.

7. The computing device of claim 6, wherein the computing device is connected to the storage system through a network.

8. The computing device of claim 6, wherein the one or more programs further comprise instructions to:
receive a user request for performing a deletion operation of the virtual machine.

9. The computing device of claim 8, wherein the one or more programs further comprise instructions to:
delete the configuration file and the disk image file of the virtual machine from the storage device in response to the user request for performing the deletion operation of the virtual machine.

10. The computing device of claim 6, wherein the virtual machine configuration file of the virtual machine indicates computing resources required by the virtual machine.

11. A non-transitory storage medium storing a set of instructions, the set of instructions capable of being executed by a processor of a computing device to implement a virtual machine operation control method, the method comprising:
establishing a communication connection between the computing device and a storage system connected to the computing device;
receiving a user request for performing a creation operation, an update operation, or a backup operation of a virtual machine in the computing device;
downloading a configuration file and a disk image file of the virtual machine from the storage system in response to the user request for performing the creation operation or the update operation of the virtual machine, and storing the configuration file and the disk image file into a storage device of the computing device;
creating the virtual machine in the computing device according to the configuration file and the disk image file; and
uploading the configuration file and the disk image file of the virtual machine to the storage system in response to the user request for performing the backup operation of the virtual machine.

12. The non-transitory storage medium of claim 11, wherein the computing device is connected to the storage system through a network.

13. The non-transitory storage medium of claim 11, wherein the method further comprises:
receiving a user request for performing a deletion operation of the virtual machine.

14. The non-transitory storage medium of claim 13, wherein the method further comprises:
deleting the configuration file and the disk image file of the virtual machine from the storage device in response to the user request for performing the deletion operation of the virtual machine.

15. The non-transitory storage medium of claim 11, wherein the virtual machine configuration file of the virtual machine indicates computing resources required by the virtual machine.
